(19) United States
(12) Patent Application Publication
(10) Pub. No.: US 2021/0226711 A1
(43) Pub. Date: Jul. 22, 2021

(54) ULTRASONIC BEACON TRACKING SYSTEMS AND METHODS

(71) Applicant: LISNR, Cincinnati, OH (US)

(72) Inventors: Srivathsan Narasimhan, Saratoga, CA (US); Craig Kawahara, San Mateo, CA (US); Eric Allen, Sammamish, WA (US)

(21) Appl. No.: 17/154,517

(22) Filed: Jan. 21, 2021

Related U.S. Application Data
(60) Provisional application No. 62/963,886, filed on Jan. 21, 2020.

(51) Int. Cl. H04B 11/00

(52) U.S. Cl. CPC H04B 11/00

(57) ABSTRACT

Methods and systems for improved device service provisioning are provided. In one embodiment, a method is provided that includes determining a plurality of beacon identifiers. The beacon identifiers may correspond to particular ultrasonic services that are available to a client device located within an environment. A first identifier may be generated based on the plurality of beacon identifiers. The first identifier may identify all of the ultrasonic services that correspond to the beacon identifiers. An ultrasonic signal may be broadcast into the environment that contains the first identifier.

### CROSS REFERENCE TO RELATED APPLICATIONS

The present application claims priority to U.S. provisional patent application No. 62/963,886 filed on Jan. 21, 2020, the entire contents of which are being incorporated herein by reference.

### TECHNICAL FIELD

The present application generally relates to systems and methods for using sonic tones to communicate digitized information.

### BACKGROUND

Data often needs to be transmitted between computing devices without connecting both devices to the same computing network. For example, in certain applications, a computing network may not exist near the computing devices, or it may be too cumbersome (e.g., may take too long) to connect one or both of the computing devices to a nearby computing network. Therefore, data may be transmitted directly from one computing device to another computing device.

### SUMMARY

The present disclosure presents new and innovative systems and methods for improved device service provisioning within an environment are provided. In a first aspect a method is provided that includes determining a plurality of beacon identifiers, respective beacon identifiers of the plurality of beacon identifiers corresponding to an ultrasonic service of a plurality of ultrasonic services available to a client device located within an environment. The method may further include, based on the plurality of beacon identifiers, generating a first identifier that identifies all of the ultrasonic services corresponding to the respective beacon identifiers, and broadcasting an ultrasonic signal into the environment, the ultrasonic signal containing the first identifier.

In a second aspect according to the first aspect, the method further includes appending a second identifier to the first identifier within the ultrasonic signal, wherein the second identifier is unique within the environment and wherein the second identifier associates the first identifier with a merchant associated with at least one ultrasonic service of the ultrasonic services.

In a third aspect according to the second aspect, the method further includes associating metadata with the second identifier, thereby associating the metadata with the merchant and storing the second identifier with the metadata in a storage.

In a fourth aspect according to the third aspect, the method further includes identifying, based on the metadata, unexpected behaviors of at least one ultrasonic service of the ultrasonic services; and storing an indication of the unexpected behavior in a storage.

In a fifth aspect according to the fourth aspect, the method further includes dynamically generating a graphical user-interface comprising a plurality of data entry fields based on the metadata and the indication.

In a sixth aspect according to any of the first through fifth aspects, the ultrasonic service is at least one of a payment service, a check-in service, a proximity marketing service, and a navigation service.

In a seventh aspect according to any of the first through sixth aspects, the method further includes, based on the broadcast of the first identifier, obtaining, from a first client device, a request for access to a first ultrasonic service of the plurality of ultrasonic services and providing access to the first ultrasonic service at the first client device.

In an eighth aspect according to the seventh aspect, the first client device communicates using ultrasonic audio transmissions.

In a ninth aspect according to any of the first through eighth aspects, the ultrasonic signal is broadcast by a beacon device associated with the environment.

In a tenth aspect according to the ninth aspect, the beacon device is associated with a merchant offering at least a subset of the plurality of ultrasonic services.

In an eleventh aspect, a system is provided that includes a processor and a memory. The memory may store instructions which, when executed by the processor, cause the processor to determine a plurality of beacon identifiers, respective beacon identifiers of the plurality of beacon identifiers corresponding to an ultrasonic service of a plurality of ultrasonic services available to a client device located within an environment. The instructions may further cause the processor to, based on the plurality of beacon identifiers, generate a first identifier that identifies all of the ultrasonic services corresponding to the respective beacon identifiers and broadcast an ultrasonic signal into the environment, the ultrasonic signal containing the first identifier.

In a twelfth aspect according to the eleventh aspect, the instructions further cause the processor to append a second identifier to the first identifier within the ultrasonic signal, wherein the second identifier is unique within the environment and wherein the second identifier associates the first identifier with a merchant associated with at least one ultrasonic service of the ultrasonic services.

In a thirteenth aspect according to the twelfth aspect, the instructions further cause the processor to associate metadata with the second identifier, thereby associating the metadata with the merchant and store the second identifier with the metadata in a storage.

In a fourteenth aspect according to the thirteenth aspect, the instructions further cause the processor to identify, based on the metadata, unexpected behaviors of at least one ultrasonic service of the ultrasonic services and store an indication of the unexpected behavior in a storage.

In a fifteenth aspect according to the fourteenth aspect, the instructions further cause the processor to dynamically generate a graphical user-interface comprising a plurality of data entry fields based on the metadata and the indication.

In a sixteenth aspect according to any of the eleventh through fifteenth aspects, the ultrasonic service is at least one of a payment service, a check-in service, a proximity marketing service, and a navigation service.

In a seventeenth aspect according to any of the eleventh through sixteenth aspects, the instructions further cause the processor to, based on the broadcast of the first identifier, obtain, from a first client device, a request for access to a first ultrasonic service of the plurality of ultrasonic services and provide access to the first ultrasonic service at the first client device.

In an eighteenth aspect according to the seventeenth aspect, the first client device communicates using ultrasonic audio transmissions.

In a nineteenth aspect according to any of the eleventh through eighteenth aspects, the ultrasonic signal is broadcast by a beacon device associated with the environment.

In a twentieth aspect, a non-transitory, computer-readable medium storing instructions. When executed by a processor, the instructions may cause the processor to determine a plurality of beacon identifiers, respective beacon identifiers of the plurality of beacon identifiers corresponding to an ultrasonic service of a plurality of ultrasonic services available to a client device located within an environment. The instructions may further cause the processor to, based on the plurality of beacon identifiers, generate a first identifier that identifies all of the ultrasonic services corresponding to the respective beacon identifiers and broadcast an ultrasonic signal into the environment, the ultrasonic signal containing the first identifier.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a system for enabling audio transmission data communication according to an exemplary embodiment of the present disclosure.

FIG. 2 illustrates an audio transmission according to an exemplary embodiment of the present disclosure.

FIG. 3A illustrates an example computing environment for transmitting beacon information according to an exemplary embodiment of the present disclosure.

FIG. 3B illustrates an example client device according to an exemplary embodiment of the present disclosure.

FIG. 3C illustrates multiple beacon identifiers being broadcast according to an exemplary embodiment of the present disclosure.

FIG. 4 illustrates a method for pairing a client device according to an exemplary embodiment of the present disclosure.

FIG. 5 illustrates a method for generating a common beacon identifier according to an exemplary embodiment of the present disclosure.

FIG. 6 illustrates a method for consuming a common beacon identifier according to an exemplary embodiment of the present disclosure.

FIG. 7 illustrates a method for generating analytics according to an exemplary embodiment of the present disclosure.

FIG. 8 illustrates a computing system and/or computing device according to an exemplary embodiment of the present disclosure.

### DETAILED DESCRIPTION

Various techniques and systems exist to exchange data between computing devices without connecting to the same communication network. For example, the computing devices may transmit data via direct communication links between the devices. In particular, data may be transmitted according to one or more direct wireless communication protocols, such as Bluetooth®, ZigBee®, Z-Wave®, Radio-Frequency Identification (RFID), Near Field Communication (NFC), and Wi-Fi® (e.g., direct Wi-Fi links between the computing devices). However, each of these protocols relies on data transmission using electromagnetic waves at various frequencies. Therefore, in certain instances (e.g., ZigBee®, Z-Wave®, RFID, and NFC), computing devices may typically require specialized hardware to transmit data according to these wireless communication protocols. In further instances (e.g., Bluetooth®, ZigBee®, Z-Wave®, and Wi-Fi®), computing devices may typically have to be communicatively paired in order to transmit data according to these wireless communication protocols. Such communicative pairing can be cumbersome and slow, reducing the likelihood that users associated with one or both of the computing devices will utilize the protocols to transmit data. Furthermore, such communication networks can have a patchy coverage due to environmental and physical conditions that attenuate or block signals (e.g. blind coverage spots by a cell tower or signal loss in a store's basement).

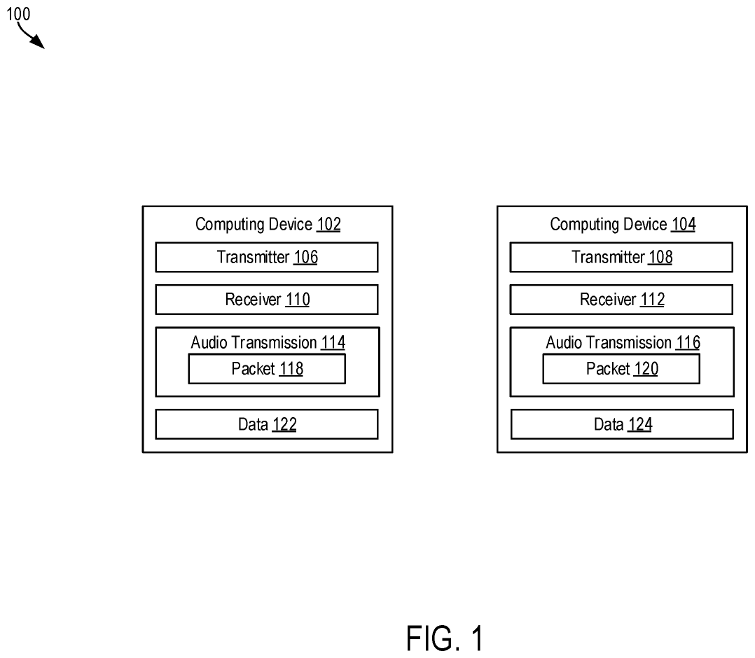

Therefore, there exists a need to wireless transmit data in a way that (i) does not require specialized hardware and (ii) does not require communicative pairing prior to data transmission. One technical solution to this problem (among others) is to transmit data using audio transmissions. For example, FIG. 1 illustrates a system 100 according to an exemplary embodiment of the present disclosure. The system 100 includes two computing devices 102, 104 configured to transmit data 122, 124 using audio transmissions 114, 116. In particular, each computing device 102, 104 includes a transmitter 106, 108 and a receiver 110, 112. The transmitters 106, 108 may include any type of device capable of generating audio signals, such as speakers. In certain implementations, the transmitters 106, 108 may be implemented as a speaker built into the computing device 102, 104. For example, one or both of the computing devices may be a smartphone, tablet computer, and/or laptop with a built-in speaker that performs the functions of the transmitter 106, 108. In other implementations, the transmitters 106, 108 may be implemented as a microphone external to the computing device 102, 104. For example, the transmitters 106, 108 may be implemented as one or more speakers externally connected to the computing device 102, 104.

The receivers 110, 112 may include any type of device capable of receiving audio transmissions and converting the audio transmissions into signals (e.g., digital signals) capable of being processed by a processor of the computing device, such as microphones. In other implementations, the receivers 110, 112 may be implemented as a microphone built into the computing device 102, 104. For example, one or both of the computing devices may be a smartphone, tablet computer, and/or laptop with a built-in microphone that performs the functions of the receivers 110, 112. In other implementations, the receivers 110, 112 may be implemented as a microphone external to the computing device 102, 104. For example, the receivers 110, 112 may be implemented as one or more microphones external to the computing device 102, 104 that are communicatively coupled to the computing device 102, 104. In certain implementations, the transmitter 106, 108 and receiver 110, 112 may be implemented as a single device connected to the computing device. For example, the transmitter 106, 108 and receiver 110, 112 may be implemented as a single device containing at least one speaker and at least one microphone that is communicatively coupled to the computing device 102, 104.

In certain implementations, one or both of the computing devices 102, 104 may include multiple transmitters 106, 108 and/or multiple receivers 110, 112. For example, the computing device 104 may include multiple transmitters 108 and multiple receivers 112 arranged in multiple locations so that the computing device 104 can communicate with the computing device 102 in multiple locations (e.g., when the computing device 102 is located near at least one of the multiple transmitters 108 and multiple receivers 112). In additional or alternative implementations, one or both of the computing devices 102, 104 may include multiple transmitters 106, 108 and/or multiple receivers 110, 112 in a single location. For example, the computing device 104 may include multiple transmitters 108 and multiple receivers 112 located at a single location. The multiple transmitters 108 and multiple receivers 112 may be arranged to improve coverage and/or signal quality in an area near the single location. For example, the multiple transmitters 108 and multiple receivers 112 may be arranged in an array or other configuration so that other computing devices 102 receive audio transmissions 114, 116 of similar quality regardless of their location relative to the transmitters 108 and receivers 112 (e.g., regardless of the location of the computing devices 102 within a service area of the transmitters 108 and receivers 112).

The computing devices 102, 104 may generate audio transmissions 114, 116 to transmit data 122, 124 to one another. For example, the computing devices 102 may generate one or more audio transmissions 114 to transmit data 122 from the computing device 102 to the computing device 104. As another example, the computing device 104 may generate one or more audio transmissions 116 to transmit data 124 from the computing device 104 to the computing device 102. In particular, the computing devices 102, 104 may create one or more packets 118, 120 based on the data 122, 124 (e.g., including a portion of the data 122, 124) for transmission using the audio transmissions 114, 116. To generate the audio transmission 114, 116, the computing devices 102, 104 may modulate the packets 118, 120 onto an audio carrier signal. The computing devices 102, 104 may then transmit the audio transmission 114, 116 via the transmitter 106, 108, which may then be received by the receiver 110, 112 of the other computing devices 102, 104. In certain instances (e.g., where the data 122, 124 exceeds a predetermined threshold for the size of a packet 118, 120), the data 122, 124 may be divided into multiple packets 118, 120 for transmission using separate audio transmissions 114, 116.

Accordingly, by generating and transmitting audio transmissions 114, 116 in this way, the computing devices 102, 104 may be able to transmit data 122, 124 to one another without having to communicatively pair the computing devices 102, 104. Rather, a computing device 102, 104 can listen for audio transmissions 114, 116 received via the receivers 110, 112 from another computing device 102, 104 without having to communicatively pair with the other computing device 102, 104. Also, because these techniques can utilize conventional computer hardware like speakers and microphones, the computing devices 102, 104 do not require specialized hardware to transmit the data 122, 124.

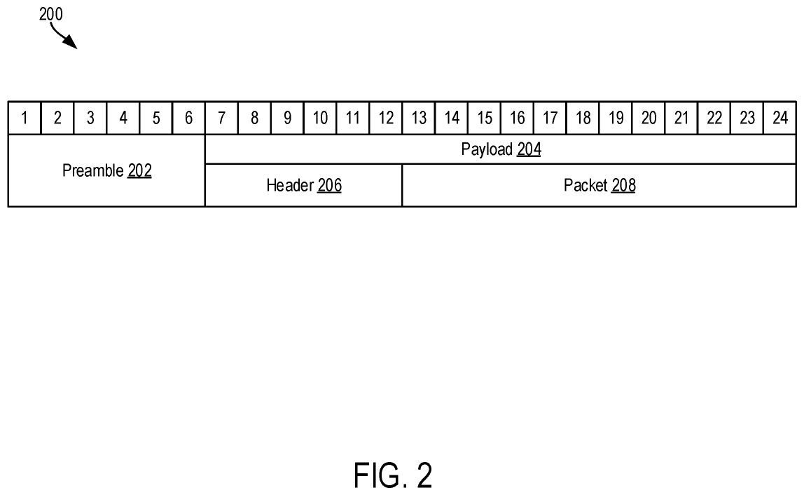

FIG. 2 illustrates an audio transmission 200 according to an exemplary embodiment of the present disclosure. The audio transmission 200 may be used to transmit data from one computing device to another computing device. For example, referring to FIG. 1, the audio transmission 200 may be an example implementation of the audio transmissions 114, 116 generated by the computing devices 102, 104. The audio transmission 200 includes multiple symbols 1-24, which may correspond to discrete time periods within the audio transmission 200. For example, each symbol 1-24 may correspond to 2 ms of the audio transmission 200. In other examples, the symbols 1-24 may correspond to other time periods within the audio transmission 200 (e.g., 1 ms, 10 ms, 20 ms, 40 ms). Each symbol 1-24 may include one or more frequencies used to encode information within the audio transmission 200. For example, the one or more frequencies may be modulated in order to encode information in the audio transmission 200 (e.g., certain frequencies may correspond to certain pieces of information). In another example, the phases of the frequencies may be additionally or alternatively be modulated in order to encode information in the audio transmission 200 (e.g., certain phase differences from a reference signal may correspond to certain pieces of information).

In particular, certain symbols 1-24 may correspond to particular types of information within the audio transmission 200. For example, the symbols 1-6 may correspond to a preamble 202 and symbols 7-24 may correspond to a payload 204. The preamble 202 may contain predetermined frequencies produced at predetermined points of time (e.g., according to a frequency pattern). In certain implementations, the preamble 202 may additionally or alternatively contain frequencies (e.g., a particular predetermined frequency) whose phase differences are altered by predetermined amounts at predetermined points of time (e.g., according to a phase difference pattern). The preamble 202 may be used to identify the audio transmission 200 to a computing device receiving the audio transmission 200. For example, a receiver of the computing device receiving audio transmissions such as the audio transmission 200 may also receive other types of audio data (e.g., audio data from environmental noises and/or audio interference). The preamble 202 may therefore be configured to identify audio data corresponding to the audio transmission 200 when received by the receiver of the computing device. In particular, the computing device may be configured to analyze incoming audio data from the receiver and to disregard audio data that does not include the preamble 202. Upon detecting the preamble 202, the computing device may begin receiving and processing the audio transmission 200. The preamble may also be used to align processing of the audio transmission 200 with the symbols 1-24 of the audio transmission 200. In particular, by indicating the beginning of the audio transmission 200, the preamble 202 may enable the computing device receiving the audio transmission 200 to properly align its processing of the audio transmission with the symbols 1-24.

The payload 204 may include the data intended for transmission, along with other information enabling proper processing of the data intended for transmission. In particular, the packets 208 may contain data desired for transmission by the computing device generating the audio transmission 200. For example, and referring to FIG. 1, the packet 208 may correspond to the packets 118, 120 which may contain all or part of the data 122, 124. The header 206 may include additional information for relevant processing of data contained within the packet 208. For example, the header 206 may include routing information for a final destination of the data (e.g., a server external to the computing device receiving the audio transmission 200). The header 206 may also indicate an originating source of the data (e.g., an identifier of the computing device transmitting the audio transmission 200 and/or a user associated with the computing device transmitting the audio transmission 200).

The preamble 202 and the payload 204 may be modulated to form the audio transmission 200 using similar encoding strategies (e.g., similar encoding frequencies and/or phase differences). Accordingly, the preamble 202 and the payload 204 may be susceptible to similar types of interference (e.g., similar types of frequency-dependent attenuation and/or similar types of frequency-dependent delays). Proper extraction of the payload 204 from the audio transmission 200 may rely on proper demodulation of the payload 204 from an audio carrier signal. Therefore, to accurately receive the payload 204, the computing device receiving the audio transmission 200 may need to account for the interference.

Symbols 1-24 and their configuration depicted in FIG. 2 are merely exemplary. It should be understood that certain implementations of the audio transmission 200 may use more or fewer symbols, and that one or more of the preamble 202, the payload 204, the header 206, and/or the packet 208 may use more or fewer symbols than those depicted and may be arranged in a different order or configuration within the audio transmission 200.

To enable ultrasonic communication between two devices, such as between the computing device 102 and the computing device 104, the two devices may communicatively “pair”, or establish initial linkage between the two devices to subsequently allow authorized and/or trusted communication between the two devices. In one specific example, the computing device 102 may be a mobile device (or other type of client device) and the computing device 104 may be a hardware device capable of transmitting or otherwise broadcasting a signal, such as a beacon device. In such a scenario, to enable trusted communication between the mobile device and the beacon device, the mobile device may pair with the beacon device. Pairing may be initiated by the beacon device or by the mobile device (i.e., the client device).

For example, to pair with the mobile device, the beacon device may transmit, using a non-sound protocol or mechanism, a universally unique identifier (referred to as a “beacon identifier”) that can be interpreted or otherwise consumed by the mobile device, e.g., by an application or operating system running on the mobile device. In some instances, the beacon device may also broadcast another identifier using an audio transmission (e.g., an ultrasonic signal) that confirms or otherwise verifies the transmitted beacon identifier was intended for a particular mobile device that actually interprets the beacon identifier. The beacon identifier may be used to determine or otherwise identify specific content and/or software services (e.g., ultrasonic services) available to the mobile device. For example, the beacon identifier may enable the beacon device to determine the mobile device's physical location, track the mobile device, and/or trigger a location-based action on the mobile device, such as a check-in on social media, enable a push notification, and/or the like.

In another example, to pair with the mobile device, the beacon device may broadcast, using an audio transmission, a beacon identifier that can be interpreted or otherwise consumed by the mobile device, e.g. by an application or operating system running on the mobile device. The beacon identifier may be used to determine or otherwise identify specific content and/or software services (e.g., ultrasonic services) available to the mobile device from the beacon device. For example, the beacon identifier may enable the beacon device to determine the mobile device's physical location, track the mobile device, and/or trigger a location-based action on the mobile device, such as a check-in on social media, enable a push notification, and/or the like.

In some instances, there may be more than one beacon identifier broadcast (e.g., broadcast over the same audio transmission) to a mobile device at a given time, thereby enabling a mobile device to pair with one or multiple beacon devices. However, attempting to transmit multiple identifiers (e.g., multiple beacon identifiers) simultaneously over the same audio transmission may present technical issues. More specifically, because an audio frequency may be shared resource, any system providing beaconing services may need to control how beaconing occurs. Stated differently, while the use of multiple beacon identifiers provides a mechanism through which a client device may access a set of specific content and/or software services, transmitting multiple beacon identifiers using audio transmission may pose compatibility and interoperability challenges. For example, broadcasting tens, hundreds, or thousands of beacon identifiers may not be scalable. Moreover, systems that use multiple beacon identifiers may not be able to generate and provide useful analytics because no technical mechanism exists that enables a system to disambiguate the anonymous nature of the beacon identifiers.

Accordingly, to solve these specific technical issues (among others), aspects of the present disclosure involve systems and methods for generating a common beacon identifier that may be used to identify multiple ultrasonic software services and/or content available to a client device (e.g., a consumer device such as a mobile phone). The common beacon identifier may be generated based on a set of individual beacon identifiers, each of which identifies a specific ultrasonic software service or specific content. Additionally, a second identifier may be injected or otherwise appended to the common beacon identifier that allows the common beacon identifier to be associated with metadata obtained or otherwise accessed within a beacon environment.

In some instances, the common beacon identifier may be encoded or otherwise embedded into an ultrasonic audio transmission and transmitted (e.g., broadcast) into a beacon environment for consumption by a client device. Any client device within a propagation range of the signal may receive the signal and common beacon identifier. In response, ultrasonic software services and/or content associated with the common beacon identifier can be utilized by, for example, an application functioning at or within the client device (e.g., such as by displaying information for on a display element of the device when the device is specifically present at the correct proximity).

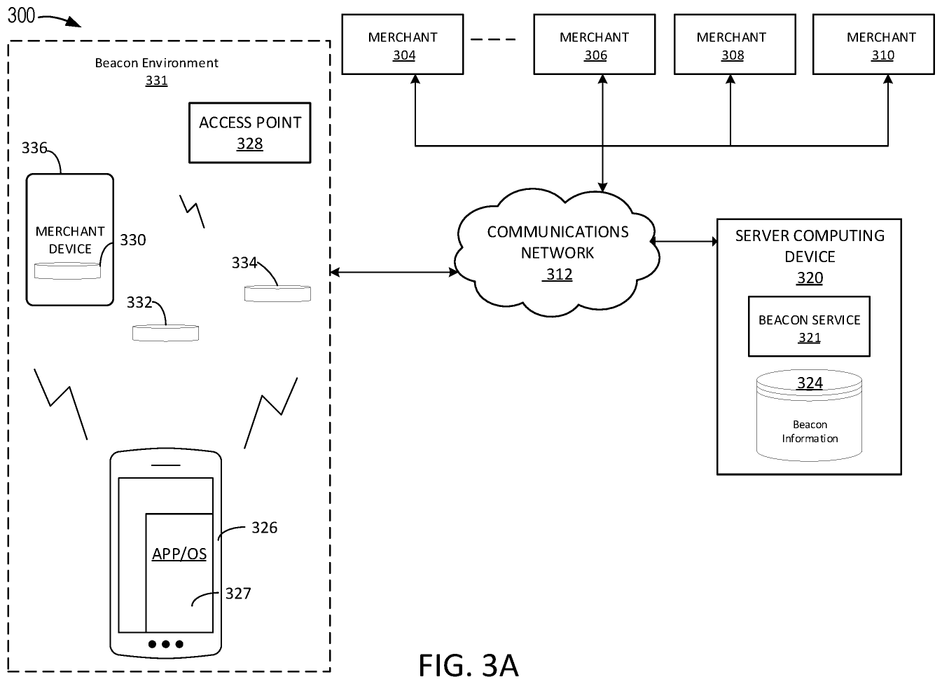

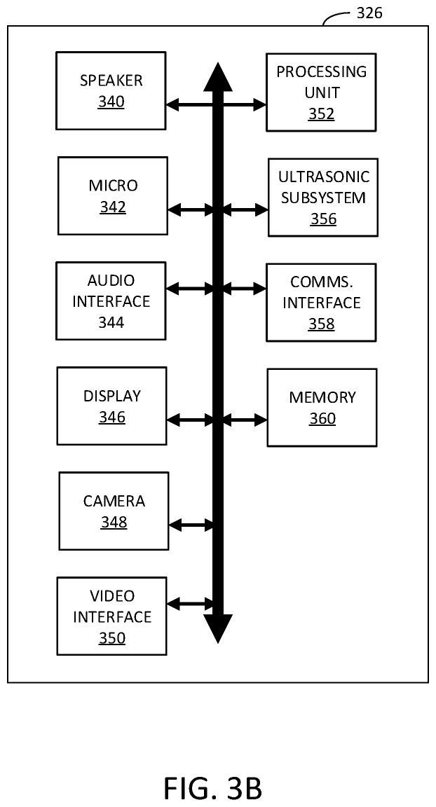

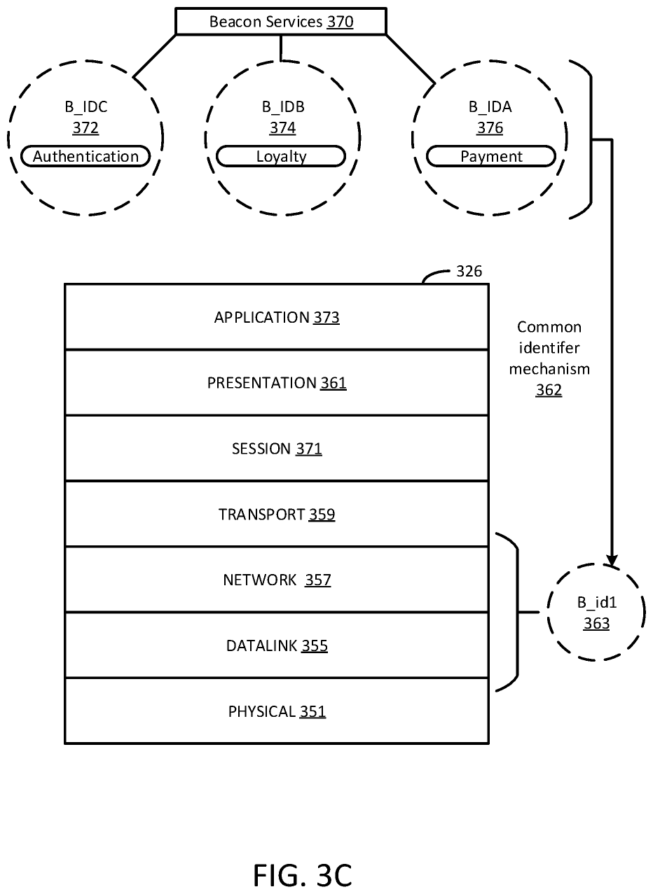

FIG. 3A illustrates an example computing environment 300 for generating and transmitting a common beacon identifier (e.g., using broadcast devices) to facilitate discovery of ultrasonic services and/or related content, according to aspects of the present disclosure. As illustrated, the computing environment 300 includes a server computing device 320. The server computing device includes a beacon service 321 that manages beacon devices 330, 332, 334 within a beacon environment 331 for a merchant 304 and/or a plurality of merchants 304a-310n. Generally speaking, a beacon environment represents an environment, such as a physical environment or location, where at least one beacon device is deployed, such as within a retail store, mass transit station, museum, exhibition, tradeshow, festival, parking lot, sporting/entertainment venue, airport, hospital, library, restaurant, theatre, and/or the like. A merchant (i.e., merchants 304, 306, 308, 310) represents any entity that deploys at least one beacon device, such as a business, firm, public/private organization, government agency/institution, etc. In one specific example, the merchants 304, 306, 308, 310 may be content providers, providing a variety of content such as text (e.g., advertising), audio (e.g., songs, albums), video, digital photographs, graphics, animations, multimedia, among other content. Alternatively, merchants may represent or otherwise provide application services and/or software services, such as payment services, check-in services, promotional services, location services, navigation services, etc., some or all of which may be ultrasonic services (e.g., provided at least in part using communication over ultrasonic audio transmissions).

The beacon environment 331 includes one or more beacon devices 330-334. Generally speaking, a beacon device or “beacon” represents a device that broadcasts its identity in the form of an identifier to nearby portable electronic devices, mobile devices, and/or other types of client devices. In the illustrated embodiment of FIG. 3A, each of the beacon devices 330, 332, 334 may be a device with various communication means including a WiFi chipset and/or a Bluetooth chipset, and/or audio transmission components, etc. The beacon devices 330, 332, 334 may be implemented using various types of computing hardware. For example, one or more of the beacon devices may be implemented as non-portable computing hardware that requires a wired power connection to operate. As another example, one or more of the beacon devices may be implemented as portable computing hardware that can be powered using a battery. In one such implementation, the beacon devices 330 may be implemented as mobile devices. The beacon devices 330, 332, 334 may correspond to one of the merchants 304, 306, 308, 310. Thus, in one example, beacon device 330 corresponds to merchant 304, beacon device 332 corresponds to merchant 306, beacon device 334 corresponds to merchant 308, and so on. In other examples, there may only be one beacon device 330 within the beacon environment 331, or there may be more than three beacon devices 330, 332, 334 within the beacon environment 331. In other examples, more than one of the beacon devices 330, 332, 334 may correspond to a single merchant, such as merchant 304.

A beacon device, such as beacon 330, may be included within (or coupled to) a merchant device 336, which may be any hardware device configured to broadcast streaming media concurrently with beacon information and/or to provide services, such as payment services, check-in services, promotional services, location services, navigation services, etc., some or all of which may be ultrasonic services. The streaming media and beacon information may be received by the client device 326 through the communications network 312. The client device 326 may receive the streaming media from the merchant device 336 over a first broadcast medium (e.g., an audio signal) and receive beacon information, such as a beacon identifier. In some implementations, the content and/or services may be received as a packet stream from the Internet and the beacon information can be included in a packet header or payload. In other instances, the content and/or services may be received using an audio transmission, such as the described in FIGS. 1-2. The merchant device 336 may be a computer, smart phone, tablet computer, media player, stereo system, television device, smart device, and/or any other hardware device that can broadcast content into an environment using, for example, a loudspeaker system and/or screen or display. Alternatively, the merchant device 336 may refer to any electronic device that is capable of wirelessly communicating with multiple electronic devices at the same time, such as a wireless access point. In one specific example, the merchant device 336 may be a point of sale (POS) device, cashier device, and/or other device including hardware, firmware and/or software for performing and/or otherwise providing various merchant-related services and functions.

The beacon devices 330, 332, 334 may communicate with a client device 326. The client device 326 includes a wireless transceiver that may be used to detect radio frequency (RF) signals and any corresponding beacon identifiers broadcast from beacon devices 330-334 when the client device 326 is within communication range of the beacon devices 330-334. In one example, the beacon devices 330-334 may be or otherwise implement BLE beacons that comply with Bluetooth Core Specification 4.0, or similar specifications. The client device 326 may further include an application/operating system 327 that can detect beacon identifiers being broadcast by the beacon devices 330-334. The client device 326 may be any of a number of available devices, such as peripheral devices, cellular telephones, smartphones, tablet PCs, touch screen PCs, hand-held computers, netbook computers, laptop computers, and the like. Additionally, the client device 326 may have processing capabilities and functionality for operating a camera, a display, and a microphone and for connecting to a network, such as Bluetooth, Wi-Fi network, Internet, and the like. In some implementations, the client device 326 may communicate wirelessly with beacon service 321 and/or the merchant device 336 through access point (AP) 328 (e.g., Wi-Fi access point) and/or a communications network 312 (e.g., the Internet).

FIG. 3B illustrates an example client device 326, according to one embodiment. As illustrated, the client device 326 may include a speaker 340 and a microphone 342 coupled to an audio interface 344. The client device 326 also includes a display 346 and a camera 348 coupled to a video interface 350. The client device includes 326 includes a processing unit 352 with an audio codec and a video codec and a memory 360. The processing unit 352 is connected to the audio and video interfaces 344 and 350 through the bus 354 (or similar connection structure) for encoding and decoding the audio and video.

In the illustrated embodiment of FIG. 3B, the client device 326 may also include an ultrasonic subsystem 356 for receiving, and, in some cases, generating and transmitting, ultrasonic signals, in conjunction with the application/operating system 327. In some embodiments, one or more speakers or one or more ultrasonic transducers may be used to transmit the ultrasonic signals, if transmission is desired. In an embodiment, the client device 326 uses one or more microphones to receive the ultrasonic signals. The ultrasonic subsystem 450 decodes the ultrasonic signal to determine any unique identifier associated with beacon devices 330-334 (although only three beacons are illustrated in FIG. 3A, it is contemplated that any number of beacons can be deployed in beacon environment 331). In one embodiment, the speaker and the microphone for the ultrasonic subsystem 356 are the microphone 342 and speaker 340. Finally, the client device 326 may include a communications network interface 358 connected to the processing unit 352 for communicating audio, video, and data packages with other devices.

Referring again to FIG. 3A, the beacon service 321 may access a beacon database 324, which may be a data store, such as a single database, distributed database, or other type of storage for storing beacon information. Beacon information may include any information related to the commissioning and operation of beacons, including but not limited to: major, minor, transmitted signal strength, packet type, packet payload data, device filter (e.g., white list), content timing data, or any other information. In some implementations, beacon devices 330-334 can be used to trigger notifications that activate features of the application 327 that is running on client device 326. For example, client device 326 can be operating in a retail store and running a shopping application related to the retail store. When a beacon broadcast is received by the client device 326, targeted content (e.g., an advertisement related to the retailer) may be presented on a display of the client device 326. In another example, in response to receipt of a beacon broadcast, the client device 326 may request a user of client device 326 (e.g., using a text notification or pop-up in an application) to “check-in” at the retail location.

In some embodiments, multiple types of beacon information and/or multiple beacon identifiers may be broadcast to the client device 326 simultaneously, wherein each beacon identifier represents a specific service or content. FIG. 3C illustrates an example of multiple beacon identifiers being simultaneously broadcast according to one embodiment. The embodiment is depicted win the context of the Open Systems Interconnection (OSI) model in which there are seven layers. Those skilled in the art will appreciate that network communications typically rely on the OSI model for modeling network communication. As shown in FIG. 3C, OSI specifies a physical layer 350 (Layer 1), a data link layer 355 (Layer 2), a network layer 357 (Layer 3), a transport layer 359 (Layer 4), a session layer 371 (Layer 5), a presentation layer 361 (Layer 6) and an application layer 373 (Layer 7).

As further illustrated, one or more beacon services 370 may be available for consumption by a client device, such as the client device 326. The beacon services 370 represent the software services and/or content available when paired to a beacon device. For example, first beacon information including a first beacon identifier “B_IDC” 372 may identify the location of the broadcast and specific content and/or a specific service being broadcast. In the illustrated embodiment, the service identified by the first beacon identifier “B_IDC” is an “Authentication” service. For example, the authentication service, once triggered, may allow a user associated with a client device to authenticate (e.g., for the purposes of accessing other beacon services 370). A device ID stored by the client device 326 can identify the type of client device receiving the broadcast of the first beacon identifier “B_IDC” 372.

Additionally, second beacon information may be broadcast that includes a second beacon identifier “B_IDB” 374, which is different from the first beacon identifier “B_IDC” 372. The second beacon identifier “B_IDB” 374 may identify specific content and/or a specific service being broadcast. In the illustrated embodiment, the service identified by the second beacon identifier “B_IDB” is a Loyalty service. For example, a user associated with a client device may use the loyalty service to access a loyalty program associated with a merchant, such as a loyalty program offering exclusive products or discounts. A device ID stored by the client device 326 can identify the type of client device receiving the broadcast of the second beacon identifier “B_IDB” 374. In yet another instance, third beacon information may be provided that includes a third beacon identifier “B_IDA” 376, which is different from the first beacon identifier“B_IDC” 372 and the second beacon identifier “B_IDB” 374. The third beacon identifier “B_IDA” 376 may identify specific content and/or a service being broadcast that is different than the content or service being broadcast or otherwise identified by the first beacon identifier “B_IDC” 372 and the second beacon identifier “B_IDB” 374. In the illustrated embodiment, the service identified by the third beacon identifier “B_IDA” is a Payment service. For example, accessing the payment service may allow a user associated with a client device to access and complete payments (e.g., via audio transmissions, via a web portal on the client device). A device ID stored by the client device 326 can identify the type of client device receiving the broadcast of the third beacon information. While the example above illustrates a first beacon information, a second beacon information, and a third beacon information, it is contemplated that any number of beacon information and/or beacon identifiers may be broadcast and/or obtained at the client device 326.

To enable management of multiple beacon identifiers being simultaneously broadcast to a client device, a globally unique identifier may be mapped to one of the first beacon identifier “B_IDC” 372, the second beacon identifier “B_IDB” 374, or the third beacon identifier “B_IDA” 376. In one specific example, a universally unique identifier “B_id1” 363, generated at the data link layer 352 (e.g., used to track data transfers from the first computing device 102 to the second computing device 104 illustrated in FIG. 1) may be mapped to one of the first beacon identifier “B_IDC” 372, the second beacon identifier “B_IDB” 374, or the third beacon identifier “B_IDA” 376. In the illustrated example, the first beacon identifier “B_IDC”, the second beacon identifier “B_IDB”, and the third beacon identifier “B_IDA” may be mapped to a global identifier “B_id1” 363 using a common beacon identifier mechanism 362. Alternatively, as will be described in further detail below, the first beacon identifier “B_IDC” 372, the second beacon identifier “B_IDB” 374, or the third beacon identifier “B_IDA” 376 may be combined into a common beacon identifier that provides access to all of the specific content and/or software services available through each of the individual beacon identifiers (e.g., the first beacon identifier, second beacon identifier, and third beacon identifier).

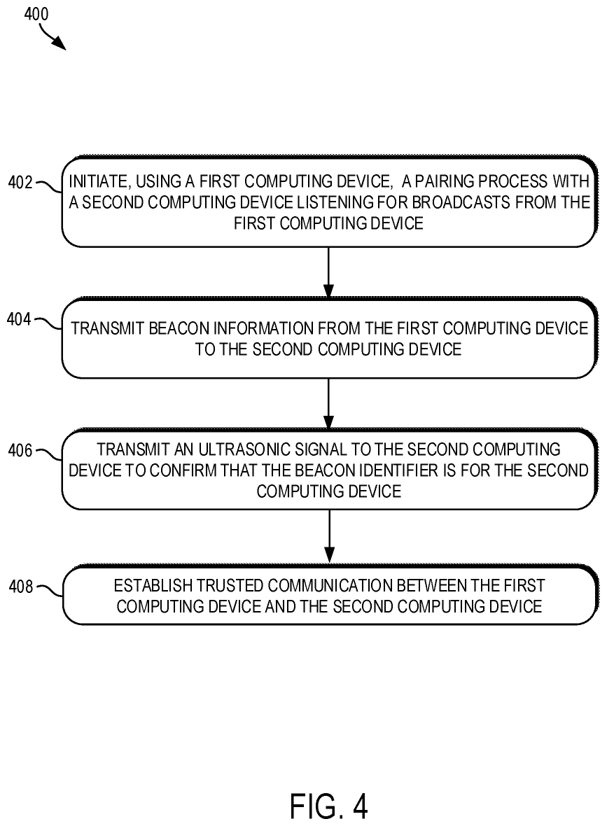

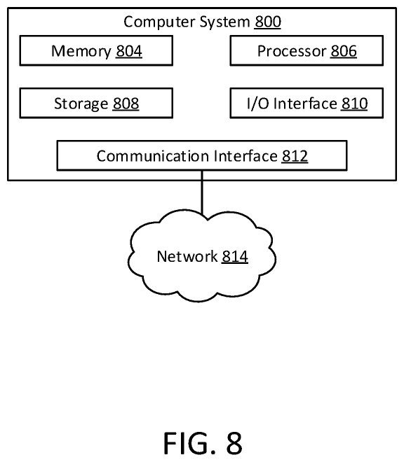

FIG. 4 illustrates a method 400 for pairing a client device according to an exemplary embodiment of the present disclosure. The method 400 may be implemented on a computer system, such as the server computing device 320 of FIG. 3A and/or the computing system of FIG. 8, described in detail below. For example, the method 400 may be implemented by the computing system 800. The method 400 may also be implemented by a set of instructions stored on a computer readable medium that, when executed by a processor, cause the computer system to perform the method. For example, all or part of the method 400 may be implemented by a CPU and a memory of the computing device 802. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks described may be optional.

As shown in FIG. 4, at block 402, a first computing device initiates a pairing process with a second computing device. For example the beacon device 330 may initiate pairing with the client device 326, which may be listening for any beacon devices that are currently broadcasting signals, such as beacon devices 330, 332, 334. In particular, pairing may be initiated by receiving a beacon signal (e.g., a predetermined audio signal) that is broadcast by the first computing device. In response to receiving the beacon signal, the second computing device and the first computing device may initiate a pairing procedure. At block 404, the first computing device transmits beacon information such as a beacon identifier to the second computing device. Referring to the example above, the beacon device 330 transmits a unique beacon identifier to the client device 326. The beacon information may correspond to a pairing process offered by the first computing process, which the second computing process can perform to communicatively pair with the first computing process. At block 406, an ultrasonic signal is transmitted to the second computing device. Referring to the example above, the beacon device 330 transmits an ultrasonic signal to the client device 326 to confirm that the client device is communicating with the appropriate beacon 330. For example, in response to receiving the beacon information at block 404, the second computing device may not begin performing the pairing process. Instead, the second computing device may wait for confirmation (e.g., a device ID) to be received from the first computing device in the form of an ultrasonic signal from the first computing device. In certain instances, in response to receiving the beacon signal at block 402 or the beacon information at block 404, the second computing device may transmit a response (e.g., via audio transmission) that contains a unique identifier of the second computing device. To confirm that the beacon information at block 404 is for the second computing device, the first computing device may transmit an ultrasonic signal containing the unique identifier of the second computing device. In certain implementations, blocks 404, 406 may be performed using a single ultrasonic audio transmission. For example, the first computing device may transmit a single audio transmission that contains both the beacon information for the pairing process and the unique identifier of the second computing device. At block 408, trusted communication is established between the first computing device and the second computing device. For example, the first and second computing devices may execute the identified computing process (which may be stored locally as executable instructions on each of the first and second computing devices) to pair with one another for secure communication. In certain instances, the trusted communication may be established over an electromagnetic communication interface (e.g., WiFi, Bluetooth, ad hoc wireless communication). In additional or alternative implementations, the trusted communication may be established over an audio interface (e.g., using audio transmissions).

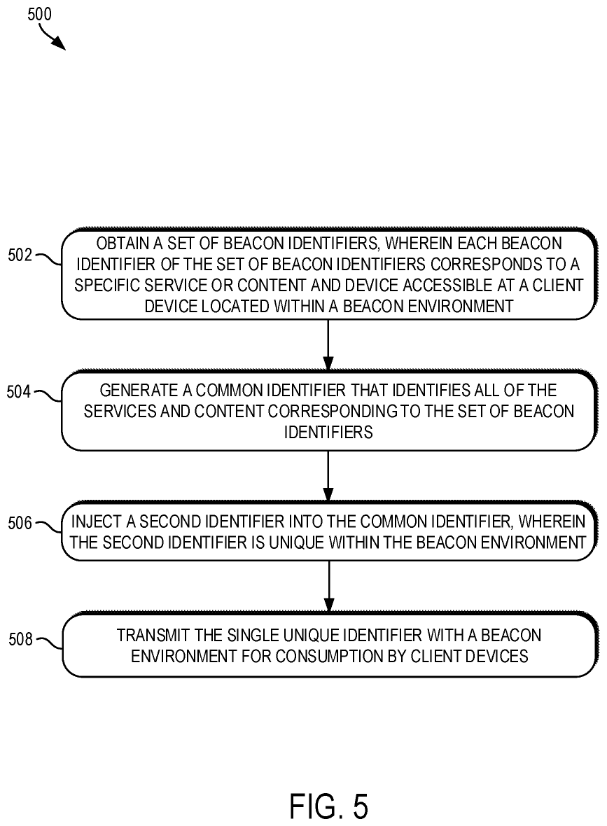

FIG. 5 illustrates a method 500 for generating a common beacon identifier, according to exemplary embodiments of the present disclosure. The method 500 may be implemented on a computer system, such as the server computing device 320 of FIG. 3A and/or the computing system of FIG. 8, described in detail below. For example, the method 500 may be implemented by the computing system 800. The method 500 may also be implemented by a set of instructions stored on a computer readable medium that, when executed by a processor, cause the computer system to perform the method. For example, all or part of the method 500 may be implemented by a CPU and a memory of the computing device 802. Although the examples below are described with reference to the flowchart illustrated in FIG. 5, many other methods of performing the acts associated with FIG. 5 may be used. For example, the order of some of the blocks may be changed, certain blocks may be combined with other blocks, one or more of the blocks may be repeated, and some of the blocks described may be optional.

As illustrated, the process 500 begins, at block 502, with obtaining or otherwise identifying a set of beacon identifiers, wherein each identifier of the set of identifiers corresponds to a specific software service and/or to specific content accessible by a client device at a specific beacon device within a beacon environment. For example, a respective beacon identifier of the set of beacon identifiers may correspond to one service, such as a payment service, check-in service, content delivers services, and/or the like. Generally speaking, “payment services” may refer to any software application or process that enables the processing of payments using a client device, such as a mobile device. Such applications and/or processes may include mobile wallet services, card-based payment services, contactless payment services, among others. “Check-in services” may refer to applications and/or processes that enable a user to identify his/her specific location using a client device, such as a mobile device. “Content delivery services” may refer to applications and/or processes that provide of specific content to client devices, such as a mobile device. For example, a user of a client device in a retail store can be provided with multimedia content associated with the retailer, based on a beacon identifier linked to the content.

Referring again to FIG. 5, at block 504, based on the set of obtained beacon identifiers, a single, common, identifier (referred to herein as “global beacon ID”) may be generated that identifies all of the software services linked by the set of beacon identifiers. Stated differently, in some implementations, the system may identify all of the individual services associated with the obtained set of identifiers and generate a global beacon ID that may be broadcasted to indicate that all of such services are available to a client device, such as the client device 326. In one example, the each beacon identifier of the set of beacon identifiers may be appended together to create the global ID identifier. The global beacon ID may further include a timestamp for identifying the location and time of the broadcast.

At block 506, a second identifier may be appended to, injected into, and/or otherwise associated with the global beacon ID. The second identifier may uniquely identify the beacon environment, such as the beacon environment 331. At block 506, a single unique identifier is transmitted for consumption by a client device and a connection is established. For example, the global beacon ID and the second identifier, in combination, may form a “single unique identifier” of the services available within the beacon environment. The single unique identifier may be transmitted within the beacon environment 331 (e.g., within an ultrasonic audio transmission) for consumption by the client device 326 and a connection (e.g., using ultrasonic audio transmissions) may be established for the purposes of utilizing one or more computing services offered by the beacon device.

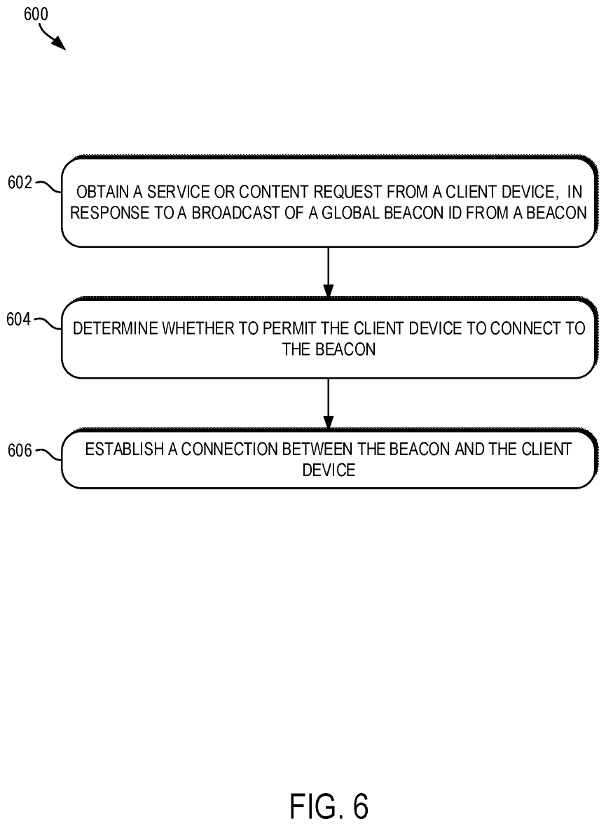

FIG. 6 illustrates a method 600 for consuming and processing global beacon IDs broadcast within a beacon environment, according to exemplary embodiments of the present disclosure. The method 600 may be implemented on a computer within a computing environment, such as the computing environment of FIG. 3A and/or the computing system of FIG. 8 described in detail below. For example, the method 600 may be implemented by the server computing device 320. The method 600 may also be implemented by a set of instructions stored on a computer readable medium that, when executed by a processor, cause the computer system to perform the method. For example, all or part of the method 600 may be implemented by a CPU and a memory of the computing system 800. Although the examples below are described with reference to the flowchart illustrated in FIG. 6, many other methods of performing the acts associated with FIG. 6 may be used. For example, the order of some of the blocks may be changed, certain blocks may be combined with other blocks, one or more of the blocks may be repeated, and some of the blocks described may be optional.

As illustrated in FIG. 6, the method 600 begins, at block 602, with obtaining a content and/or service request from a client device, in response to a broadcast of a global beacon ID (e.g., an identifier transmitted according to the method 500). For example, the beacon 330 may receive a pairing request from the client device 326 in response to the signal. The client device 326 transmits the pairing request to the beacon that is identified by the global beacon ID. For example, as part of the beacon data structure a list of pre-defined codes nay be included that indicate what services the beaconing device has available.

At block 604, the applicable beacon determines whether to permit the client device to pair and responds to the pairing request. At block 606, when the paring is established (e.g., similar to the pairing process 400), a connection (e.g., an ultrasonic communication connection) is established between the beacon and the client device.

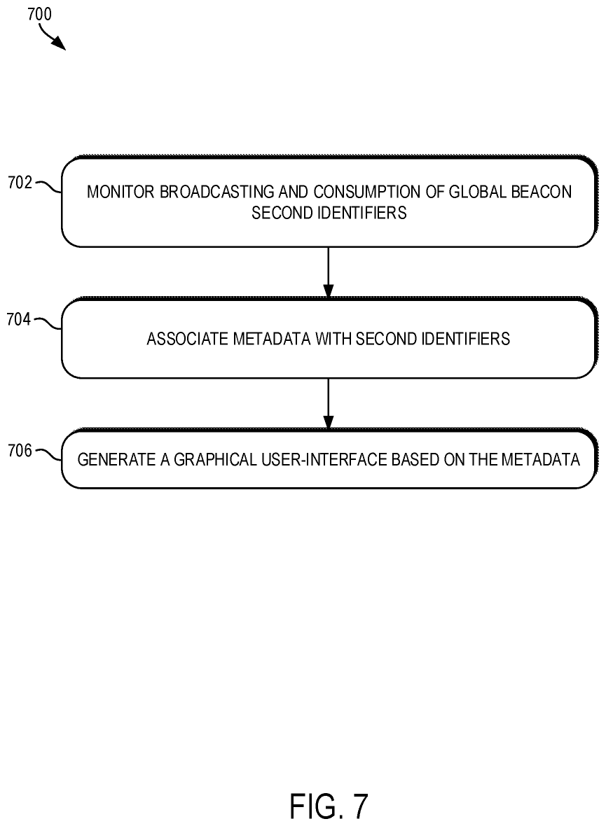

FIG. 7 is an illustration of an exemplary method 700 for generating analytics related to various devices located within a beacon environment, or otherwise communicating within a beacon environment. The method 700 may be implemented on a computer within a computing environment, such as the computing environment of FIG. 3A and/or the computing system of FIG. 8 described in detail below. For example, the method 700 may be implemented by the server computing device 320. The method 700 may also be implemented by a set of instructions stored on a computer readable medium that, when executed by a processor, cause the computer system to perform the method. For example, all or part of the method 700 may be implemented by a CPU and a memory of the computing system 800. Although the examples below are described with reference to the flowchart illustrated in FIG. 7, many other methods of performing the acts associated with FIG. 7 may be used. For example, the order of some of the blocks may be changed, certain blocks may be combined with other blocks, one or more of the blocks may be repeated, and some of the blocks described may be optional.

The process 700 starts at block 702, where transmissions of global beacon IDs, injected with second identifiers (according to the method 500), are monitored within a beacon environment. At block 704, metadata may be associated with the second identifier associated with the global beacon ID during monitoring. The metadata may provide specific and detailed information about the broadcast device (e.g., the merchant device 336) broadcasting the global beacon ID and/or the client device consuming the global broadcast ID. For example, the metadata may include information such as the geographic location of the beacon and/or merchant device, the streaming media being broadcast, and/or the type of merchant device (e.g., radio, TV, digital media player, computer) that includes the beacon (where applicable). Regarding the client device, the metadata may include a device ID that uniquely identifies the client device and the type of client device receiving the broadcast (e.g., smart phone, tablet computer, media player, and/or wearable device). The metadata may further include various user interactions performed on the client device in response to the received content and/or services. Once the metadata is embedded or otherwise associated with the second identifier, the system may provide or otherwise generate various analytics that enable: 1) monitoring of the various devices functioning with the beacon environment; 2) generation of proactive notifications of updated resources within the beacon environment; and 3) and/or the like.

For example, service performance could be monitored and associated back to the originating device. If service performance fell below a pre-defined threshold, that device could be identified as requiring further investigation and maintenance. As another example, metadata could be used to distinguish between multiple merchants.

At block 706, one or more graphical user interfaces (GUIs) may be generated, based upon the metadata associated with the global beacon ID. Such graphical user interface(s) may be output for display to one or more users at one or more client devices (e.g., a client device associated with the merchants 304, 306, 308, 310). In one specific example, the graphical user-interfaces may include a plurality of fields and/or interactive components, such as forms, buttons, media streams, windows, icons, menus, and/or other graphical objects that visualize the metadata to a user.

FIG. 8 illustrates an example computer system 800 that may be utilized to implement one or more of the devices and/or components of FIG. 3A, such as the beacon management service 320, the merchant device 336, and/or the user device client device 326. In particular embodiments, one or more computer systems 800 perform one or more steps of one or more methods described or illustrated herein. In particular embodiments, one or more computer systems 800 provide the functionalities described or illustrated herein. In particular embodiments, software running on one or more computer systems 800 performs one or more steps of one or more methods described or illustrated herein or provides the functionalities described or illustrated herein. Particular embodiments include one or more portions of one or more computer systems 800. Herein, a reference to a computer system may encompass a computing device, and vice versa, where appropriate. Moreover, a reference to a computer system may encompass one or more computer systems, where appropriate.

This disclosure contemplates any suitable number of computer systems 800. This disclosure contemplates the computer system 800 taking any suitable physical form. As example and not by way of limitation, the computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 806, memory 804, storage 808, an input/output (I/O) interface 810, and a communication interface 812. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 806 includes hardware for executing instructions, such as those making up a computer program. As an example and not by way of limitation, to execute instructions, the processor 806 may retrieve (or fetch) the instructions from an internal register, an internal cache, memory 804, or storage 808; decode and execute the instructions; and then write one or more results to an internal register, internal cache, memory 804, or storage 808. In particular embodiments, the processor 806 may include one or more internal caches for data, instructions, or addresses. This disclosure contemplates the processor 806 including any suitable number of any suitable internal caches, where appropriate. As an example and not by way of limitation, the processor 806 may include one or more instruction caches, one or more data caches, and one or more translation lookaside buffers (TLBs). Instructions in the instruction caches may be copies of instructions in memory 804 or storage 808, and the instruction caches may speed up retrieval of those instructions by the processor 806. Data in the data caches may be copies of data in memory 804 or storage 808 that are to be operated on by computer instructions; the results of previous instructions executed by the processor 806 that are accessible to subsequent instructions or for writing to memory 804 or storage 808; or any other suitable data. The data caches may speed up read or write operations by the processor 806. The TLBs may speed up virtual-address translation for the processor 806. In particular embodiments, processor 806 may include one or more internal registers for data, instructions, or addresses. This disclosure contemplates the processor 806 including any suitable number of any suitable internal registers, where appropriate. Where appropriate, the processor 806 may include one or more arithmetic logic units (ALUs), be a multi-core processor, or include one or more processors 802. Although this disclosure describes and illustrates a particular processor, this disclosure contemplates any suitable processor.

In particular embodiments, the memory 804 includes main memory for storing instructions for the processor 806 to execute or data for processor 806 to operate on. As an example, and not by way of limitation, computer system 800 may load instructions from storage 808 or another source (such as another computer system 800) to the memory 804. The processor 806 may then load the instructions from the memory 804 to an internal register or internal cache. To execute the instructions, the processor 806 may retrieve the instructions from the internal register or internal cache and decode them. During or after execution of the instructions, the processor 806 may write one or more results (which may be intermediate or final results) to the internal register or internal cache. The processor 806 may then write one or more of those results to the memory 804. In particular embodiments, the processor 806 executes only instructions in one or more internal registers or internal caches or in memory 804 (as opposed to storage 808 or elsewhere) and operates only on data in one or more internal registers or internal caches or in memory 804 (as opposed to storage 808 or elsewhere). One or more memory buses (which may each include an address bus and a data bus) may couple the processor 806 to the memory 804. The bus may include one or more memory buses, as described in further detail below. In particular embodiments, one or more memory management units (MMUs) reside between the processor 806 and memory 804 and facilitate accesses to the memory 804 requested by the processor 806. In particular embodiments, the memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory implementations, this disclosure contemplates any suitable memory implementation.

In particular embodiments, the storage 808 includes mass storage for data or instructions. As an example and not by way of limitation, the storage 808 may include a hard disk drive (HDD), a floppy disk drive, flash memory, an optical disc, a magneto-optical disc, magnetic tape, or a Universal Serial Bus (USB) drive or a combination of two or more of these. The storage 808 may include removable or non-removable (or fixed) media, where appropriate. The storage 808 may be internal or external to computer system 800, where appropriate. In particular embodiments, the storage 808 is non-volatile, solid-state memory. In particular embodiments, the storage 808 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 808 taking any suitable physical form. The storage 808 may include one or more storage control units facilitating communication between processor 806 and storage 808, where appropriate. Where appropriate, the storage 808 may include one or more storages 808. Although this disclosure describes and illustrates particular storage, this disclosure contemplates any suitable storage.

In particular embodiments, the I/O Interface 810 includes hardware, software, or both, providing one or more interfaces for communication between computer system 800 and one or more I/O devices. The computer system 800 may include one or more of these I/O devices, where appropriate. One or more of these I/O devices may enable communication between a person and computer system 800. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 810 may include one or more device or software drivers enabling processor 806 to drive one or more of these I/O devices. The I/O interface 810 may include one or more I/O interfaces 810, where appropriate. Although this disclosure describes and illustrates a particular I/O interface, this disclosure contemplates any suitable I/O interface or combination of I/O interfaces.

In particular embodiments, communication interface 812 includes hardware, software, or both providing one or more interfaces for communication (such as, for example, packet-based communication) between computer system 800 and one or more other computer systems 800 or one or more networks 814. As an example and not by way of limitation, communication interface 812 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 814 and any suitable communication interface 812 for it. As an example and not by way of limitation, the network 814 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 800 may include any suitable communication interface 812 for any of these networks, where appropriate. Communication interface 812 may include one or more communication interfaces 812, where appropriate. Although this disclosure describes and illustrates a particular communication interface implementations, this disclosure contemplates any suitable communication interface implementation.

The computer system 800 may also include a bus. The bus may include hardware, software, or both and may communicatively couple the components of the computer system 800 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
determining a plurality of beacon identifiers, respective beacon identifiers of the plurality of beacon identifiers corresponding to an ultrasonic service of a plurality of ultrasonic services available to a client device located within an environment;
based on the plurality of beacon identifiers, generating a first identifier that identifies all of the ultrasonic services corresponding to the respective beacon identifiers; and
broadcasting an ultrasonic signal into the environment, the ultrasonic signal containing the first identifier.

2. The method of claim 1, further comprising:
appending a second identifier to the first identifier within the ultrasonic signal, wherein the second identifier is unique within the environment and wherein the second identifier associates the first identifier with a merchant associated with at least one ultrasonic service of the ultrasonic services.

3. The method of claim 2, further comprising:
associating metadata with the second identifier, thereby associating the metadata with the merchant; and
storing the second identifier with the metadata in a storage.

4. The method of claim 3, further comprising:
identifying, based on the metadata, unexpected behaviors of at least one ultrasonic service of the ultrasonic services; and
storing an indication of the unexpected behavior in a storage.

5. The method of claim 4, further comprising dynamically generating a graphical user-interface comprising a plurality of data entry fields based on the metadata and the indication.

6. The method of claim 1, wherein the ultrasonic service is at least one of a payment service, a check-in service, a proximity marketing service, and a navigation service.

7. The method of claim 1, further comprising:
based on the broadcast of the first identifier, obtaining, from a first client device, a request for access to a first ultrasonic service of the plurality of ultrasonic services; and
providing access to the first ultrasonic service at the first client device.

8. The method of claim 7, wherein the first client device communicates using ultrasonic audio transmissions.

9. The method of claim 1, wherein the ultrasonic signal is broadcast by a beacon device associated with the environment.

10. The method of claim 9, wherein the beacon device is associated with a merchant offering at least a subset of the plurality of ultrasonic services.

11. A system comprising:
a processor; and
a memory storing instructions which, when executed by the processor, cause the processor to:
determine a plurality of beacon identifiers, respective beacon identifiers of the plurality of beacon identifiers corresponding to an ultrasonic service of a plurality of ultrasonic services available to a client device located within an environment;
based on the plurality of beacon identifiers, generate a first identifier that identifies all of the ultrasonic services corresponding to the respective beacon identifiers; and
broadcast an ultrasonic signal into the environment, the ultrasonic signal containing the first identifier.

12. The system of claim 11, wherein the instructions further cause the processor to:
append a second identifier to the first identifier within the ultrasonic signal, wherein the second identifier is unique within the environment and wherein the second identifier associates the first identifier with a merchant associated with at least one ultrasonic service of the ultrasonic services.

13. The system of claim 12, wherein the instructions further cause the processor to:
associate metadata with the second identifier, thereby associating the metadata with the merchant; and
store the second identifier with the metadata in a storage.

14. The system of claim 13, wherein the instructions further cause the processor to:
identify, based on the metadata, unexpected behaviors of at least one ultrasonic service of the ultrasonic services; and
store an indication of the unexpected behavior in a storage.

15. The system of claim 14, wherein the instructions further cause the processor to dynamically generate a graphical user-interface comprising a plurality of data entry fields based on the metadata and the indication.

16. The system of claim 11, wherein the ultrasonic service is at least one of a payment service, a check-in service, a proximity marketing service, and a navigation service.

17. The system of claim 11, wherein the instructions further cause the processor to:
based on the broadcast of the first identifier, obtain, from a first client device, a request for access to a first ultrasonic service of the plurality of ultrasonic services; and
provide access to the first ultrasonic service at the first client device.

18. The system of claim 17, wherein the first client device communicates using ultrasonic audio transmissions.

19. The system of claim 11, wherein the ultrasonic signal is broadcast by a beacon device associated with the environment.

20. A non-transitory, computer-readable medium storing instructions which, when executed by a processor, cause the processor to:
determine a plurality of beacon identifiers, respective beacon identifiers of the plurality of beacon identifiers corresponding to an ultrasonic service of a plurality of ultrasonic services available to a client device located within an environment;
based on the plurality of beacon identifiers, generate a first identifier that identifies all of the ultrasonic services corresponding to the respective beacon identifiers; and
broadcast an ultrasonic signal into the environment, the ultrasonic signal containing the first identifier.
